(19) United States
(12) Patent Application Publication
(10) Pub. No.: US 2012/0266863 A1
(43) Pub. Date: Oct. 25, 2012

(54) Solar-Hydrogen Hybrid Storage System for Naval and Other Uses

(76) Inventors: Surendra Saxena, Miami, FL (US); Yong X. Tao, Denton, TX (US)

(21) Appl. No.: 13/090,253

(22) Filed: Apr. 20, 2011

(51) Int. Cl. F24J 2/00; H01M 8/06; F03G 6/00; F28F 7/00; C01B 3/04; C01B 6/04

(52) U.S. Cl. 126/569; 423/658.2; 423/647; 60/641.8; 165/185; 429/421

(57) ABSTRACT

The invention is using a hydrogen-containing solid as an energy storage material for naval and stationary uses. The system is designed and analyzed optimally for producing thermal energy necessary to dissociate magnesium hydride which in turn produces the needed hydrogen to operate a fuel-cell and meet the electricity demand. The collected hydrogen is used to power the various energy needs of the Navy as well as of homes. In addition, the solar thermal system may also be used to provide heat to hot water, and other heating needs. The system has an overall energy efficiency between 20% and 30% with both thermal and hydrogen storage capability for overall energy storage and provides smooth energy needs of a building.

### CROSS REFERENCE TO RELATED APPLICATIONS

Not applicable.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

1. Field of the Invention This invention relates to processes and systems for using solar to produce metal hydrides used for a source of hydrogen storage.

2. Background Of The Invention

Identification and significance of the problem

We need to “provide energy when the renewable resource is not available, i.e., the sun is not shining and the wind is not blowing and to eliminate the inherent instability of renewable power”. This invention is for providing a solution to this problem. Essentially we are considering powering an operation such as the energy uses of a house, or of larger structures that Navy uses or even the ships of moderate sizes for Navy or cruise liners. We have created a system that will meet all the energy requirements with a largely fossil-fuel free operation.

Distribution of electricity across the country and the globe is a major problem particularly in many rural areas and in the developing world. Our solution involves the solar energy supplemented by energy from hydrogen stored in a dry solid and therefore could be available even in remote areas.

### BRIEF SUMMARY OF THE INVENTION

In preferred embodiments there is provided an invention for powering operation such as the energy uses of a house, or of larger structures that require powewr or even the ships of moderate sizes for naval or cruise liners.

The invention involves the use of solar energy supplemented by energy from hydrogen stored in a dry solid and therefore could be available even in remote areas. With this system, we can produce enough hydrogen on the site such as a house in the country with 5 hours of sunshine.

The invention also includes the use of magnesium hydride or any hydride in obtaining hydrogen for the above systems.

The invention also includes a hydrogen generator which uses a recyclable hydride.

The invention also includes a system of solar concentrators which provides solar power to the hydride for dissociation.

The invention also includes a hydrogen collector in which hydrogen is stored for various uses which may involve direct burning of hydrogen or using it with the fuel cells.

The invention also includes processes and systems for thermally heating and dissociating such hydride to release hydrogen with or without a catalyzer.

The heat being provided by solar heating using non-imaging concentrator which can produce hot fluid up to required high temperatures. The thermal requirements can be scaled up or down depending on the demand.

The heater described here is for 20 KWH/day of electricity load and at 40% fuel cell conversion rate, it requires 1.5 kg H₂ or 19.4 kg MgH₂ per day, or 136 kg MgH₂ per week. This can be scaled up or down according to the demand.

This system will use a heat exchanger surface area of 1 m² (Assuming an average overall heat transfer coefficient of 0.2 kW/m²-K, and a reactor wall temperature of 50° C. higher than the dissociating temperature (i.e., 300° C. dissociation temperature for Mg-hydride)). The area may be proportionally increased or reduced as the demand may be.

We claim that our solution which involves the solar energy supplemented by energy from hydrogen stored in a dry solid could be available even in remote areas.

### BRIEF DESCRIPTION OF THE DRAWINGS

FIG. 1 shows a graphic depiction of a solar-hydro house using the invention herein with a hydride container of 0.4×0.4×0.4 meter which would accommodate hydride for a week's supply. Portion of this hydride is fed into a smaller container for daily release of hydrogen which may be fed to a fuel cell for use in the non sunshine hours. Hydrogen may also be used for many other house-hold uses.

FIG. 2 shows a graph of Typical Solar Irradiation impacting a system as described herein.

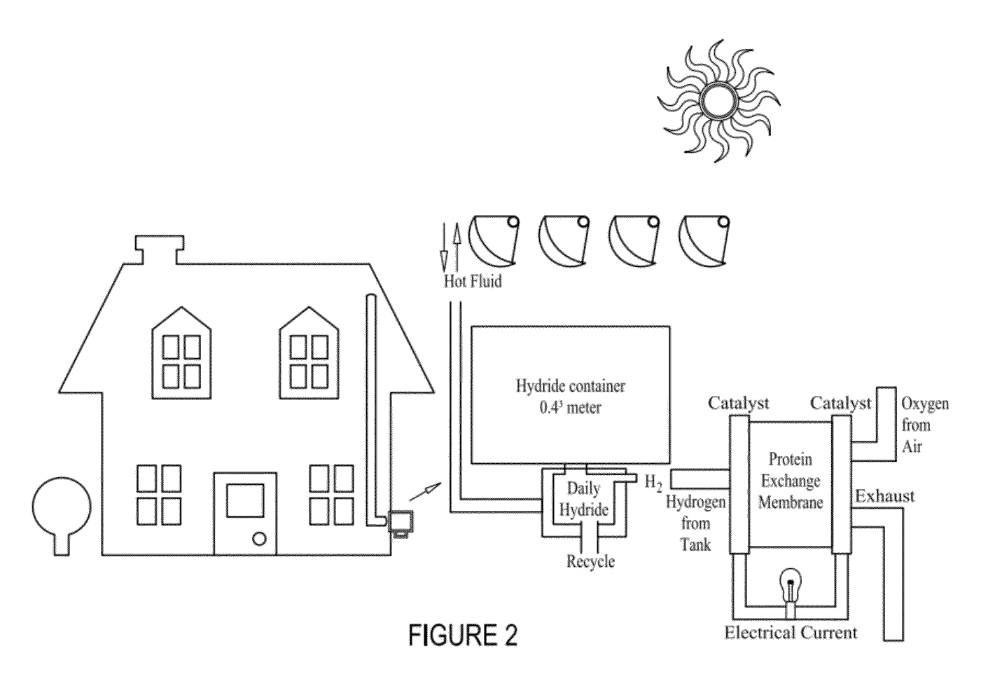

### DETAILED DESCRIPTION OF THE INVENTION

### Technical Feasibility of the Invention

### Example Calculation:

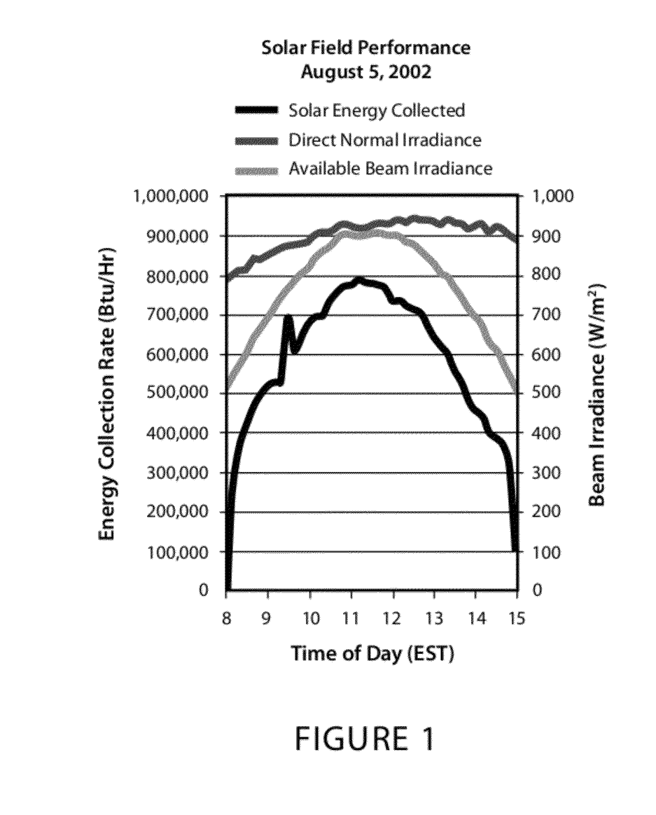

With a typical normal solar irradiation of 800 W/m² (FIG. 1), and an average solar field efficiency of 40% (50% with improved reflector [5]), the solar thermal system using non-imaging concentrator can produce hot fluid up to 350° C. Considering additional heat losses through piping and reactor, we have designed hot fluid output temperature at 300° C. With 80% heat exchanger efficiency, we receive 800 W/m²×0.4×0.8=256 W/(m² roof area) at the reactor end. A 10 KW (reactor end) demo unit will be designed to produce a roughly 50 KWH per day of thermal energy, needing about 40 m² roof area.

Assuming 20 KWH/day of electricity load and 40% fuel cell conversion rate, we need 20 KWH/0.4/33.30=1.5 kg H₂ or 19.4 kg MgH₂ per day, or 136 kg MgH₂ per week. We select a hot fluid storage capacity of 720 MJ (equivalent to 200 KWH) thermal energy for four days. We may have extra three-day hydrogen storage in case of cloudy/rainy days.

Further assuming a peak load of 3 kW electricity or 7.5 kW H₂ we have 0.225 kg/hour H₂ dissociating rate for MgH₂, or 2.91 kg/hour MgH₂. The kinetic rate of dissociation at such high temperatures is only several minutes. Considering 1 kWH heat will dissociate 1.033 kg MgH₂ (ΔH at 400 C), we need 10.1 MJ (2.82 kWH) thermal energy per hour. Therefore a 10 KW reactor is able to produce nearly three times of peak load; therefore, with extra capacity to produce extra H₂ for storage.

Assuming an average overall heat transfer coefficient of 0.2 kW/m²-K, and a reactor wall temperature of 50° C. higher than the dissociating temperature (i.e., 300° C. dissociation temperature), we have a heat exchanger surface area, A, equal to

A=10 kW/(0.2 kW/m²-K×50° C.)=1 m²

If we select a half-inch diameter (0.0127 m) tubing for the heat exchanger, we need a total length of the tubing, L=1 m²/(3.14×0.0127 m)=25 m, which has an equivalent volume of 0.00328 m³. If we process 10 KWH heat (10 KW system runs for an hour), it can dissociate about 0.8 kg H₂, or processing 10.33 kg MgH₂. Therefore, we have 0.00167 m³ for the fuel (MgH₂). Considering a heat exchanger with 0.4 volume fraction, a total volume for reactor can be 0.00328 m³/0.4=0.008202 m³ (or 0.2×0.2×0.2 m), which can easily house the fuel compartment (the volume fraction for fuel is 0.00167 m³/0.008202 m³=0.2). The remaining 0.4 gives a plenty room for optimization of space need balance among the heat exchanger components (fitting and piping), H₂ product and MgH₂.

### Hydrogen Energy Storage:

We have ascertained that MgH₂ is the best material available for this purpose. For the pure MgH₂, the following information is well known through many publications:
(1) High gravimetric (7.6 wt. %) and volumetric (130 kg H₂/m³) storage capabilities
(2) Low cost
(3) Endothermic desorption reaction
(4) Severe surface oxidation and pyrophoricity
(5) Sluggish hydrogen diffusion kinetics
(6) Metal-Hydride volume mismatch→large nucleation energy barrier→high temperature and pressure for activation
(7) Large enthalpy of hydride formation.

The points 1 and 2 are in favor of the solid as a storage material and others are not. Points 3 to 7 are important for automobile transportation but not critical to use of the hydride for our present purpose. For example 3, 6 and 7 relate to the temperature of dissociation. It has to be generally below 100° C. for automobile use but for ships, if solar energy can be used the temperature could be much higher. The kinetics is also not critical because we may have 30 minutes or more. In summary, we have ascertained that i) the temperature of dissociation can be achieved with solar energy and ii) the kinetics of dissociation is suitable.

### Suitability of a Hydride

Hydrogen storage stands at the very forefront as a potential savior element of our future. In principle, hydrogen can be stored either in its elemental form, as a gas or liquid, or in a chemical form. As discussed in [1] and by others, an ideal solid hydrogen-storage material for practical applications should, for both economic and environmental reasons, should have the following qualities:
(i) High storage capacity: minimum 6.5 wt % abundance of hydrogen and at least 65 g/L of hydrogen available from the material.
(ii) It should dissociate at low temperatures for transportation use in automobiles, ideally between 60-120° C.
(iii) The dissociation reaction should be reversible at low temperatures with desorption cycle: low temperature of hydrogen, desorption and low pressure of hydrogen absorption (a plateau pressure of the order of a few bars at room temperature). The cycles should number in hundreds if not in thousands.
(iv) Low cost comparable to gasoline costs.
(v) Low-toxicity of a non-explosive and possibly inert (to water and oxygen) storage medium.

In spite of our search for decades, no ideal solid storage exists that fulfills all the requirements; some come close but lack one or more of the qualifications as outlined above.

The problems that face us in our present pursuit of the goal to provide a hydrogen based storage system that could use the solar energy for hydrogen desorption are somewhat different. We no longer have to be strict about the hydrogen density of our storage material and a hydrogen content of 5 wt % may be usable. Furthermore, the dissociation temperature could be significantly higher than needed for automobile storage material. The relaxation of these two requirements provides us the possibility to explore other materials that are usually rejected from consideration for automotive use.

Magnesium based hydrides meet practically all the requirements except one, namely the temperatures of dissociation and hydridization. As pointed out above this is less stringent for the naval and other stationary use than the automotive use and for this purpose we will seek the solar power for the energy. Magnesium hydride offers the highest energy density of all reversible hydrides applicable for hydrogen storage [2]. Although hydrogen adsorption/desorption kinetics are too slow to form the basis of a practical hydrogen store for automobiles, we will show that for the naval and stationary uses, the kinetic rate is not critical. The ocean liners, the navy ships, the cruise ships and other large stationary buildings provide ideal sites for using the solar-hydro hybrid method. This technology will produce hydrogen while the sun is shining and permit us to use hydrogen for energy when there is not enough sun. The calculations presented in the previous section are based on magnesium hydride and we can develop this process without any further research on this topic. The hydride has been very well researched. However, the author of this invention has access to quite unique facilities and it may be possible to further improve the properties of this material.

MgH₂ is hexagonal with a dissociation temperature of ˜300 C at 1 bar. The energy calculations have been done with the above assumption and the dissociation of a pure MgH₂ and would then represent the extreme case. Several possibilities have been explored which will enhance the absorption and desorption reactions. Several studies have explored the effect of size and of mixing with catalysts of various kinds (see FIGS. 3 and 4 [3]). The best material determination has been made on the basis of the availability of solar energy and the costs of pre-processing the hydride. For this invention, we have taken unprocessed pure magnesium hydride. Anything we do more will be an improvement.

### Kinetics

Experimental method: Reagents was mixed together by mortar-and-pestle or ball milling method. Pure hydride or mixtures are pressed into pellets (½′ diameter) under 3000 psi pressure. The usual amount of the mixture used for hydrogen generation experiments is about 0.4 g. All the sample handling and loading is conducted in an Ar-filled glovebox (TerraUniversal). Quartz tube with one end sealed and loaded with a sample is put into a tubular furnace. Another end of the quartz tube is connected to the water filled graduated cylinder. After sample loading system is evacuated and flushed with Ar gas several times. Kinetics of hydrogen generation reaction is studied in isothermal approach by measuring the volume of hydrogen gas formed in a reaction. The hydrogen gas is collected in a water-filled graduated cylinder. Partial pressure of water vapor and water column height pressure are extracted from the total pressure to get hydrogen partial pressure in the cylinder. Finally, hydrogen volume formed in the reaction is corrected to standard conditions.

X-ray powder diffraction is done using Bruker GADDS/D8 X-ray system with Apex Smart CCD Detector and direct-drive rotating anode. The MacSci rotating anode (Molybdenum) operates with a 50 kV generator and 20 mA current. X-ray beam size can vary from 50 to 300 μm. The usual collection time is 1200 s.

Raman spectroscopic measurements are conducted at room temperature by using Raman spectrometer in the back scattering configuration. Ti³+-sapphire laser pumped by an argon ion laser is tuned at 785 nm. The laser is operated at 100 mW. Raman spectra are collected with 10 min exposure time by using high throughput holographic imaging spectrograph with volume transmission grating, holographic notch filter and thermoelectrically cooled CCD detector (Physics Spectra) with the resolution of 4 cm⁻¹.

### Some Kinetic/Catalysis Results

The calculations we presented before do not take into account the possible improvement we could make in processing the hydride. Thus it is possible to reduce the temperature of the dissociation of the hydride and the production of hydrogen which will reduce the power needed; this may happen if we ball mill the hydride and reduce grain size and/or use a catalyst [3].

In summary, it appears that by choosing an appropriate mixture such as two hydrides or an oxide catalyst such as Nb₂O₅, we may reduce the temperature of the reversible reaction by tens of degrees.

### Energy Balance and Cost Calculations

The solar energy component was amply discussed under example calculation in a previous section. We must still consider other costs involved in producing the hydride and recycling the metal back to hydride.

The hydriding reaction Mg+H₂=MgH₂ is exothermic (ΔH=−2.54E-02 kwh/mol).

The cost for production of hydrogen via reacting MgH₂ with water and creating hydrogen and magnesium oxide and then reducing MgO to Mg by a solid-oxide-membrane process (7) was discussed by McClane (6); it came to $3.88 per kg of H₂. Since that includes the cost of reducing MgO, we anticipate that the cost for us will be much less. The fossil fuel based cost of hydrogen is $1.65/kg. Hydrogen may also be produced from solar heat or from nuclear power. We will investigate the various modes of hydrogen production and their cost and environmental impact. We will also investigate the costs of delivery of the hydride and of removal of the spent fuel and the regeneration of the hydride.

The solar-hydro hybrid method will be useful in a variety of applications which include not only the navy buildings but also many stationary structures, large buildings and dwellings

### REFERENCES

1. Wojciech Grochala and Peter P. Edwards, “Thermal Decomposition of the Non-Interstitial Hydrides for the Storage and Production of Hydrogen”, Chem. Rev. 2004, 104, 1283-1315.

2. B. Bogdanovic, K. Bohmhammel, B. Christ, A. Reiser, K. Schlichte, R. Vehlen and U. Wolf, J. Alloys Compd., 1999,282,84-92.

3. Simon R. Johnson, Paul A. Anderson, Peter P. Edwards, Ian Gameson James W. Prendergast, Malek Al-Mamouri, David Book, Rex Harris, John D. Speight and Allan Walton, “Chemical activation of MgH2; a new route to superior hydrogen storage materials”, Chem. Commun., 2005,2823-2825

4. Gagik Barkhordarian, Thomas Klassen, R [symbol] udiger Bormann, “Fast hydrogen sorption kinetics of nanocrystalline Mg using Nb2O5 as catalyst”, Scripta Materialia 49 (2003) 213-217.

5. Randy Gee, Gilbert Cohen, and Ken Greenwood, 2003, “Operation And Preliminary Performance of the Duke Solar Power Roof™: A Roof-Integrated Solar Cooling and Heating System,” Proceedings of ASME, www.solargenix.com/pdf/ASMEPowerRoof.pdf.

6. Andrew W. McClaine, “Chemical Hydride Slurry for Hydrogen Production and Storage”, Chemical Hydrogen Storage Systems Analysis Meeting, Argonne National Laboratory, Oct. 12,2005

7. Uday B. Pal and Adam C. Powell IV JOM, “The Use of Solid-Oxide-Membrane Technology for Electrometallurgy”, May 2007; 59, 5; ABI/INFORM Trade & Industry, pg. 44.

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable Equivalents.

What is claimed as the invention:

1. A method of powering operation such as the energy uses of a house, or of larger structures that require power or even the ships of moderate sizes for naval or cruise liners.

2. A method of using solar energy supplemented by energy from hydrogen stored in a dry solid and therefore could be available even in remote areas. With this system, we can produce enough hydrogen on the site such as a house in the country with 5 hours of sunshine.

3. Use of magnesium hydride or any hydride in obtaining hydrogen for the claims 1 and 2.

4. A hydrogen generator which uses a recyclable hydride.

5. A system of solar concentrators which provides solar power to the hydride for dissociation and A hydrogen collector in which hydrogen is stored for various uses which may involve direct burning of hydrogen or using it with the fuel cells.

6. Thermally heating and dissociating such hydride to release hydrogen with or without a catalyzer.

7. The heat being provided by solar heating using non-imaging concentrator which can produce hot fluid up to required high temperatures. The thermal requirements can be scaled up or down depending on the demand.

8. The heater described here is for 20 KWH/day of electricity load and at 40% fuel cell conversion rate, it requires 1.5 kg H₂ or 19.4 kg MgH₂ per day, or 136 kg MgH₂ per week. This can be scaled up or down according to the demand.

9. This system will use a heat exchanger surface area of 1 m² (Assuming an average overall heat transfer coefficient of 0.2 kW/m²-K, and a reactor wall temperature of 50° C. higher than the dissociating temperature (i.e., 300° C. dissociation temperature for Mg-hydride)). The area may be proportionally increased or reduced as the demand may be.

10. We claim that our solution which involves the solar energy supplemented by energy from hydrogen stored in a dry solid could be available even in remote areas.
